(19) United States
(12) Patent Application Publication
(10) Pub. No.: US 2023/0400102 A1
(43) Pub. Date: Dec. 14, 2023

(54) FLUID CONTROL DEVICE

(71) Applicant: MIRAIAL CO., LTD., Tokyo (JP)

(72) Inventors: Tsuyoshi Nagashima, Tokyo (JP); Seiya Tamaribuchi, Tokyo (JP)

(73) Assignee: MIRAIAL CO., LTD., Tokyo (JP)

(21) Appl. No.: 18/033,736

(22) PCT Filed: Oct. 29, 2020
(86) PCT No.: PCT/JP2020/040716

§ 371 Date: Apr. 25, 2023

(51) Int. Cl. F16K 1/12; F16K 27/02

(52) U.S. Cl. CPC F16K 1/12; F16K 27/02

(57) ABSTRACT

A device for controlling a flow of a fluid includes a flow path having an inflow port and an outflow port; a valve body in the flow path between the inflow port and the outflow port; a valve seat on which the valve body can be seated; an elastic member for urging the valve seat or the valve body in a direction of approaching or separating the valve body to or from the valve seat; and a working fluid chamber that expands or contracts in the direction of separating or approaching the valve body from or to the valve seat by feeding or discharging a working fluid, wherein a part of the valve body is on an extension of a linear flow path central axis on the inflow port side across the valve body and the valve seat, and on an extension of a linear flow path central axis on the outflow port side, and wherein the valve seat or the valve body is displaceable in an axial direction of the linear flow path center axis on the inflow port side and the linear flow path central axis on the outflow port side.

### CROSS-REFERENCE TO RELATED APPLICATION

This application is a national phase entry, under 35 U.S.C. 371, of International Application No. PCT/JP 2020/040716, filed Oct. 29, 2020, the disclosure of which is incorporated herein by reference in its entirety.

### TECHNICAL FIELD

The present invention relates to a fluid control device for controlling the flow of a fluid, and more particularly, it proposes a technique capable of suppressing a pressure loss when a controlling fluid passes through the fluid control device.

### BACKGROUND ART

A fluid control device that can be installed in the middle of a chemical transport line or other various piping in the industrial field functions to control a flow rate of a liquid such as chemical liquids and other fluids to be controlled passing therethrough, by opening and closing a flow path with a valve body and a valve seat inside the device.

Such a fluid control device includes an air driven type device using a pneumatic actuator converting a change in pressure due to feeding or discharging of air, i.e., a working fluid, into physical movement, as a drive mechanism for displacing the valve body and the like, as well as an electrically operated type device using a solenoid actuator or the like that causes physical movement based on the supply or interruption of current (see, for example, Patent Literature 1).

However, in the electrically operated type fluid control device, internal precision parts therein may corrode during use depending on the type of the controlling fluid such as a chemical solution whose flow is controlled by the device. In this case, there is concern that the reliability of the fluid control device will be reduced, and further that it will lead to breakage. For that reason, the air driven type fluid control device may be desirable in certain applications.

As the air driven type fluid control device, for example, Patent Literature 2 discloses “a diaphragm valve, the diaphragm valve being configured to open and close a space between a first flow path and a second flow path by contacting or separating a diaphragm connected to a drive shaft of an actuator with or from a valve seat provided at a boundary between the first flow path and the second flow path formed in a body, wherein the diaphragm valve comprises: a valve body portion in contact with the valve seat; a membrane portion spreading outwardly from the valve body; and a fixing portion formed on an outer periphery of the membrane portion, wherein the membrane portion comprises: a vertical portion connected to the valve body and formed in a vertical direction; a horizontal portion connected to the fixing portion and formed in a horizontal direction; and a connecting portion having an arcuate cross section for connecting the vertical portion to the horizontal portion, wherein a tip of the drive shaft is provided with a back-up integrated into the diaphragm to receive the membrane portion while being in contact with the vertical portion and the connecting portion, and wherein the closing or opening is carried out without inverting the membrane portion”.

### CITATION LIST

### Patent Literature

### [PTL 1]

Japanese Patent No. 5990356 B

### [PTL 2]

Japanese Patent No. 5138863 B

### SUMMARY OF INVENTION

### Technical Problem

In the air driven fluid control device as described above, as in those described in Patent Literature 2, the pneumatic actuator is generally arranged at a part of the circumferential direction of a tubular flow path-forming member making up the flow path in the device so as to protrude to the outside of the flow path-forming member. Further, the valve body driven by the pneumatic actuator is arranged at a position deviated from an extension line of a flow path central axis at an inflow port and an outflow port of the flow path, and is displaced in a direction orthogonal to the flow path center axis upon driving.

Due to such arrangement and displacement direction of the valve body, the conventional fluid control device will have the flow path bending at multiple positions so that the direction of the flow of the controlling fluid flowing from the inflow port is significantly changed to a direction substantially orthogonal to the flow path central axis at the inflow port and the outflow port in the position where the valve body is arranged. Therefore, such a fluid control device has a problem that a pressure loss increases when the controlling fluid passes therethrough.

The present invention has been made to solve such problems. An object of the present invention is to provide a fluid control device capable of suppressing a pressure loss when a controlling fluid passes therethrough.

### Solution to Problem

The fluid control device is a fluid control device for controlling a flow of a fluid, the fluid control device comprising: a flow path having an inflow port and an outflow port, the flow path being configured to allow a controlling fluid to flow; a valve body arranged in the middle of the flow path between the inflow port and the outflow port; a valve seat on which the valve body can be seated; an elastic member for urging the valve seat or the valve body in a direction of approaching or separating the valve body to or from the valve seat; and a working fluid chamber that expands or contracts in the direction of separating or approaching the valve body from or to the valve seat by feeding or discharging a working fluid, wherein a part of the valve body is present on an extension line of a linear flow path central axis on the inflow port side across the valve body and the valve seat, and on an extension line of a linear flow path central axis on the outflow port side, and wherein the valve seat or the valve body is displaceable in at least one axial direction of the linear flow path center axis on the inflow port side and the linear flow path central axis on the outflow port side.

Here, it is preferable that the extension line of the linear flow path central axis at the inflow port is parallel to the extension line of the linear flow path central axis at the outflow port.

More preferably, the extension line of the linear flow path central axis at the inflow port coincides with the extension line of the linear flow path central axis at the outflow port.

In this case, the extension line of the linear flow path central axis at the inflow port and the extension line of the linear flow path central axis at the outflow port preferably passes through a center of a cross section of the valve body along a plane orthogonal to the extension lines.

In the fluid control device according to the present invention, it is preferable that the elastic member is arranged on an outer side of the flow path so as to surround the flow path.

The fluid control device according to the present invention may comprise: a cylindrical movable member displaceable in the axial direction; a pair of flow path members each having an inflow port or an outflow port, the pair of flow path members being positioned on both sides across the movable member; and an elastic tube member disposed between the pair of flow path members, the elastic tube member being deformable in accordance with relative approaching and separating displacement of the valve seat to and from the valve body. In this case, the valve body is provided at a tip portion of one of the flow path members, and a part of the elastic tube member in the axial direction is supported from a back side of the elastic tube member by the movable member to form the valve seat.

In the above fluid control device, both central axes of the movable member and the pair of flow path members are on the same straight line as the linear flow path central axes on the inflow port side and the outflow port side.

Further, the fluid control device may comprise a fluid pressure actuator provided around the movable member, the fluid pressure actuator having the working fluid chamber and operating to displace the movable member in the axial direction by feeding or discharging the working fluid to or from the working fluid chamber.

Here, it is preferable that the elastic member is arranged at a position adjacent to the fluid pressure actuator on an outer peripheral side of the elastic tube member around the other flow path member.

Further, in the fluid control device as described above, the one flow path member may comprise: the valve body at the tip potion; a cylindrical flow path portion located on a rear end side of the one flow path member; and a connecting portion for connecting the valve body to the cylindrical flow path portion. The connecting portion may have at least one communicating hole formed to communicate an interior of the cylindrical flow path portion with an internal space of the elastic tube member around the one flow path member.

It is preferable that a plurality of communication holes are formed at intervals around the one flow path member.

In addition, a surface of the valve body facing the valve seat side preferably comprises: an annular convex portion protruding toward the valve seat side at a peripheral edge of the surface; and a central convex portion at a center of the surface, the central convex portion gradually protruding on the valve seat side toward the center side.

Further, it is preferable that a back surface on a back side of the valve body facing the valve seat side has a conical shape.

### Advantageous Effects of Invention

According to the fluid control device of the present invention, at least a part of the valve body is present on the extension line of each of the linear flow path central axes on the inflow port side and on the outflow port side separated from the valve body, and the valve body or the valve seat is displaceable in at least one axial direction of the flow path central axes on the inflow port side and on the outflow port side, so that the pressure loss can be suppressed to a lower level when the controlling fluid passes therethrough.

### BRIEF DESCRIPTION OF DRAWINGS

FIG. 1 is a partial cross-sectional perspective view in an axial direction, showing a fluid control device according to one embodiment of the present invention.

FIG. 2 is a perspective view of the fluid control device in FIG. 1.

FIG. 3 is a plane view of the fluid control device in FIG. 1.

FIG. 4 is a front view of the fluid control device in FIG. 1.

FIG. 5 is a side view of the fluid control device in

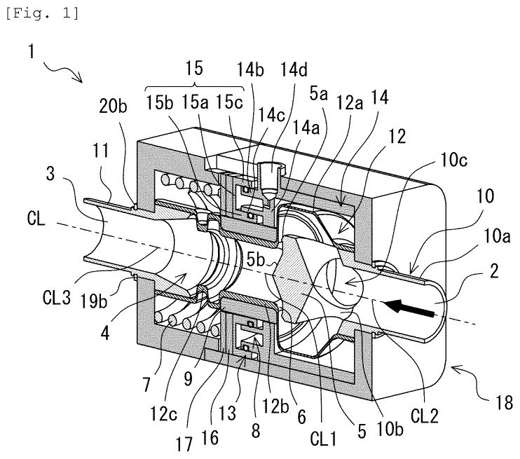

FIG. 1.

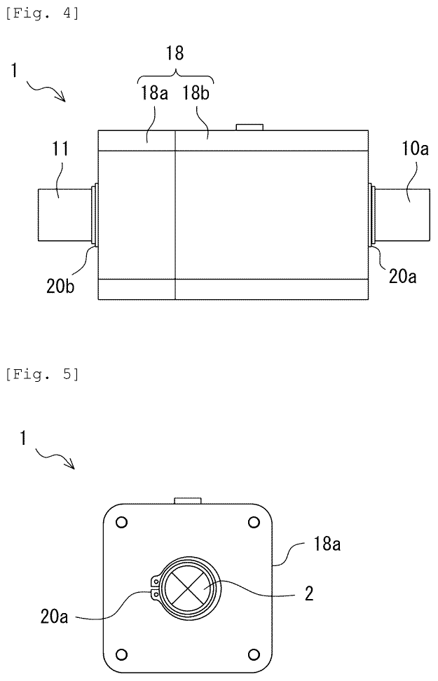

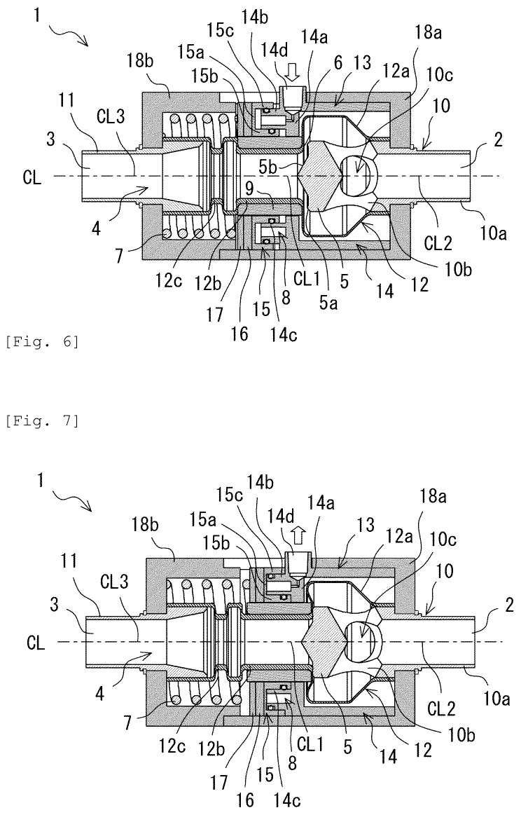

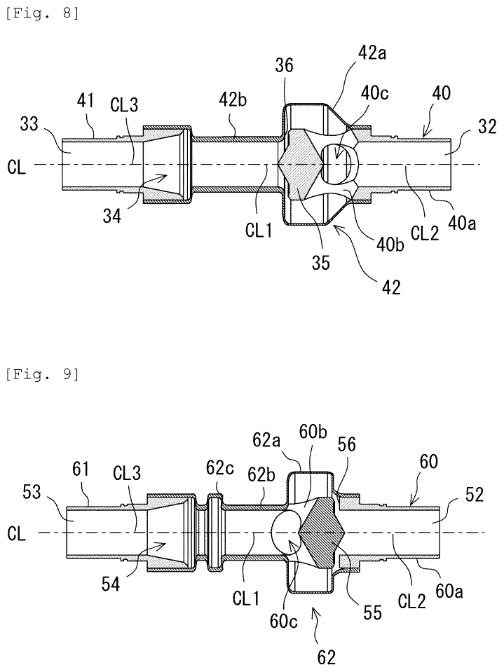

FIG. 6 is a cross-sectional view in an axial direction along the line VI-VI in FIG. 3.

FIG. 7 is a cross-sectional view similar to FIG. 6, showing that a valve body is seated on a valve seat of the fluid control device in FIG. 1.

FIG. 8 is a cross-sectional view along an axial direction, showing one and other flow path members and an elastic tube member in a fluid control device according to another embodiment, which are taken out from the fluid control device.

FIG. 9 is a cross-sectional view along an axial direction, showing one and other flow path members and an elastic tube member in a fluid control device according to another embodiment, which are taken out from the fluid control device.

FIG. 10 is a cross-sectional view along an axial direction, showing one and other flow path members and an elastic tube member in a fluid control device according to another embodiment, which are taken out from the fluid control device.

FIG. 11 is a graph showing a relationship between a flow rate and a differential pressure in a test using a fluid control device according to each of Example and Comparative Example.

FIG. 12 is a graph showing a relationship between a flow rate and a power consumption in a test using a fluid control device according to each of Example and Comparative Example.

### DESCRIPTION OF EMBODIMENTS

Embodiments of the present invention will be described below in detail with reference to the drawings.

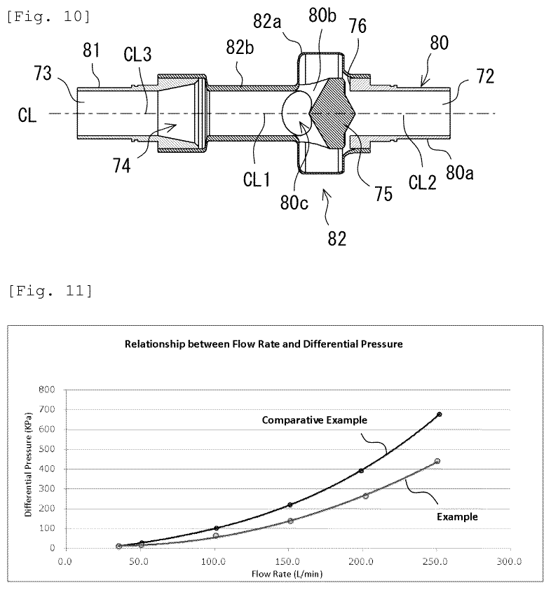

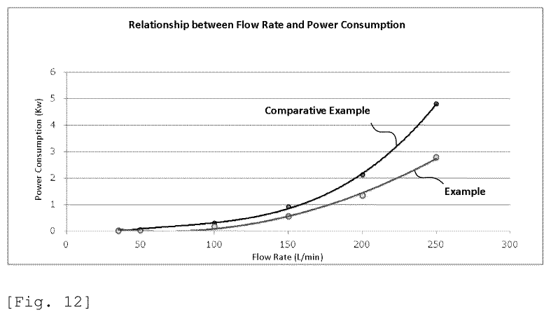

A fluid control device 1 illustrated in FIGS. 1 to 7 flows a controlling fluid such as a liquid through the interior, and perform control such as an increase/decrease in a flow rate of the controlling fluid or stop of the flow of the controlling fluid. For example, in the production of semiconductors and electronic parts in microelectronics, the fluid control device 1 may be provided in the middle of a pipe through which ultrapure water, a chemical liquid or the like flows.

For example, the illustrated fluid control device 1 has an inflow port 2 and an outflow port 3, both of which have a circular cross section orthogonal to a flow path central axis CL indicated by the dashed line in FIGS. 1, 6 and 7, the fluid control device 1 includes: a flow path 4 through which a controlling fluid flows; a valve body 5 arranged in the middle of the flow path 4 from the inflow port 2 to the outflow port 3; a valve seat 6 on which the valve body 5 can be seated; an elastic member 7 for urging the valve seat 6 or the valve body 5 in a direction of approaching or separating the valve 50 to or from the valve seat 6; and a working fluid chamber 8 in which a working fluid is fed or discharged to generate expansion or contraction in the direction of approaching or separating the valve 50 to or from the valve seat 6.

Here, in order to distinguish the fluid such as ultrapure water or chemical liquid passing through the flow path 4 from the working fluid fed to the working fluid chamber 8, the fluid whose flow is controlled by the fluid control device 1 is referred to as a controlling fluid. The controlling fluid is also simply referred to as a fluid. On the other hand, the working fluid that is fed to and discharged from the working fluid chamber 8 is often air, but it is not limited to this, and can be other gases or liquids.

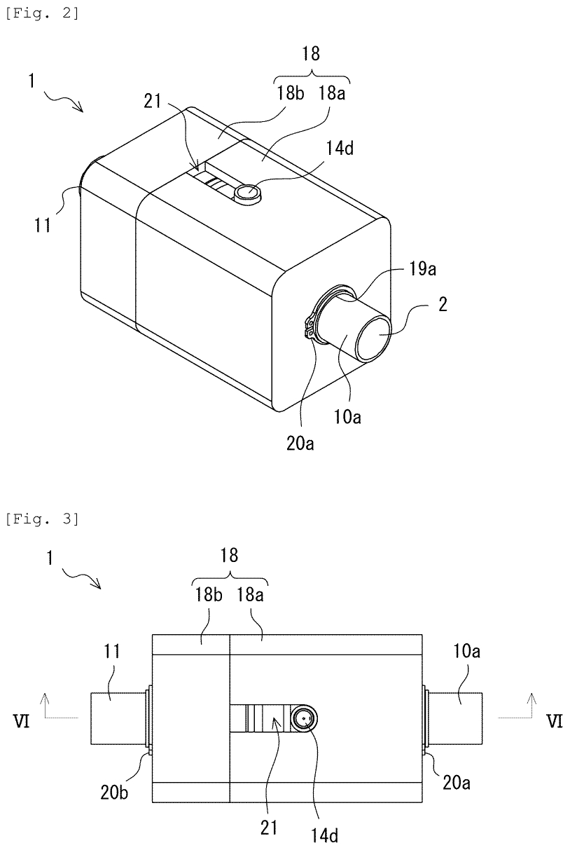

It is possible to interchange the inflow port 2 and the outflow port 3 of the fluid control device 1 so that the fluid can flow in a direction opposite to the direction of the arrow in FIG. 2. However, in the fluid control device 1, the fluid flows from the inflow port 2 into the flow path 4 and flows through the flow path 4 along the flow direction indicated by the arrow in FIG. 1 to the outflow port 3. At least part of the valve body 5 disposed in the middle of the flow path 4 is present on an extension line of a flow path central axis CL2 that is liner on the inflow port side across the valve body 5 and the valve seat 6 in the flow direction, and on an extension line of a flow path central axis CL3 that is linear on the outflow port 3 side. It is to understood that the flow path center axis means a central line passing through the center of the flow path 4 or the center of the figure in a cross section orthogonal to the flow direction of the fluid.

In response to the feeding or discharging of the working fluid to or from the working fluid chamber 8 as indicated by the white arrow as shown in FIGS. 6 and 7, the displacement is generated in a direction of approaching or separating the valve body 5 to or from the valve seat 6. In this embodiment, the valve seat 6 or the valve body 5 is configured so as to be displaceable along the axial direction(s) of the linear flow path central axis CL2 on the inflow port 2 side and/or the linear flow path central axis CL3 on the outflow port 3 side. That is, the relative approaching direction and separating direction of the valve body 5 and the valve seat 6 are linear, and coincide with at least one axial direction of the flow path central axis CL2 on the inflow port 2 side and the flow path central axis CL3 on the outflow port 3 side.

The valve body 5 is thus present on the extension line of the flow path central axis CL2 and on the flow path central axis CL3, and the valve body 5 and the valve seat 6 can be linearly displaced in the axial direction(s) of the flow path central axis CL2 and/or the flow path central axis CL3, so that it is possible to reduce bent points of the flow path 4 of the fluid control device 1 as compared with the conventional fluid control device as described above. As a result, the pressure loss when the controlling fluid passes through the fluid control device 1 can be suppressed to a lower level.

More particularly, the fluid control device 1 includes: a cylindrical movable member 9 such as a cylinder, which is displaceable along at least one axial direction of the flow path central axis CL2 on the inflow port 2 side and the flow path central axis CL3 on the outflow port 3 side; a pair of flow path members 10, 11 each having the inflow port 2 or the outflow port 3 and positioned on both sides across the movable member 9 in the flow direction; and an elastic tube member 12 which is arranged between the flow path members 10, 11 and which is deformable in accordance with the relative reaching and separating displacement of the valve seat 6 to and from the valve body 5. The elastic tube member 12 is arranged such that one end portion of the elastic tube member 12 surrounds the one flow path member 10 and the other end portion surrounds the other flow path member 11, and the elastic tube member 12 extends to the interior of the movable member 9 between the one flow path member 10 and the other flow path member 11 and is arranged between their flow path members 10, 11. The elastic tube member 12 is mainly positioned around the one flow path member 10, and has: an increased diameter portion 12a having larger inner and outer diameters than the other portions; an intermediate portion 12b positioned on an inner side of the movable member 9; and an easily deformable portion 12c positioned on the other flow path member 11 side and having a large diameter portion and a small diameter portion connected between the other flow path member 11 and the movable member 9, wherein these portions are continuous and integrally formed.

In particular, here, as in this embodiment, the extension line of the linear flow path central axis CL2 at the inflow port 2 and the extension line of the linear flow path central axis CL3 at the outflow port 3 are preferably parallel to each other, and further, the extension line of the flow path central axis CL2 preferably coincides with the extension line of the flow path central axis CL3. In the illustrated fluid control device 1, all the center axes of the cylindrical movable member 9 and the pair of flow path members 10, 11 are on the same straight line as the linear flow path central axis CL2 at the inflow port 2 and the linear flow path central axis CL3 at the outflow port 3. Moreover, the flow path central axis CL of the entire flow path 4 includes not only the flow path central axis CL2 and the flow path central axis CL3 as described above, but also a flow path central axis CL1 at the valve body 5 or the valve seat 6, thereby becoming one straight line. In this case, as shown in the figure, it is possible to form the flow path 4 that is straight as a whole with substantially no bent portion, which is extremely effective from the viewpoint of reducing the pressure loss.

However, although illustration is omitted, one flow path member and the other flow path member are arranged in a deviate fashion such that the straight channel center axis at the inlet and the straight channel center axis at the outlet are parallel to each other and deviate from each other. Also, the one flow path member and the other flow path member can be arranged so that the extension lines of their central axes intersect or are at a twisted position, and in this case, the linear flow path central axis at inflow port and the linear flow path central axis at the outflow port are not parallel to each other. Even in such a fluid control device, the bent positions can be reduced and the pressure loss can be suppressed if at least a part of the valve body is present on the extension line of the straight flow path central axis at the inflow port and on the extension line of the linear flow path central axis at the outflow port.

Further, preferably, in at least a part of the region where the valve body 5 and the valve seat 6 are relatively displaced, the extension line of the linear flow path central axis CL2 at the inflow port 2 and the extension line of the linear flow path central axis CL3 at the outlet 3 preferably pass through the center of the cross section of the valve body 5 along a plane orthogonal to the extension lines. This allows at least regions from the inflow port 2 side to the valve body 5 and from the valve body 5 to the outflow port 3 side of the flow path 4 to be straight, so that the pressure loss can be sufficiently reduced. In the illustrated fluid control device 1, the extension line of the flow path central axis CL2 and the extension line of the flow path central axis CL3 pass through the center of the cross section of the valve body 5 over the entire region where the valve body 5 and the valve seat 6 are relatively displaced.

The valve body 5 is provided at a tip portion of the one flow path member 10 on the movable member 9 side among the above members included in the fluid control device 1. Further, the end face of the movable member 9 on the one flow path member 10 side is covered with a part of the elastic tube member 12 in the axial direction (transition portion from the intermediate portion 12b to the increased diameter portion 12a), and that part of the elastic tube member 12 facing the valve body 5 forms the valve seat 6 on which the valve body 5 can be seated. The valve seat 6 which is that part of the elastic tube member 12 in the axial direction is supported by the movable member 9 from its back side when the side facing the one flow path member 10 is defined as a front side. Such a valve seat 6 is pushed from the back side by the end face of the movable member 9 as the movable member 9 is displaced toward the one flow path member 10 side, so that it is displaced in the direction of approaching the valve body 5 at the tip portion of the flow path member 10, and the valve body 5 is seated thereon. The flow of the fluid in the flow path 4 is stopped accordingly.

Further, when the movable member 9 is displaced toward the other flow path member 11 side, the easily deformable portion 12c of the elastic tube member 12 is pushed toward the other flow path member 11 side by the end face of the movable member 9 on the other flow path member 11 side. As a result, the valve seat 6, which is a part of the elastic tube member 12 in the axial direction, is displaced in the direction away from the valve body 5 at the tip portion of the one flow path member 10. At this time, the valve body 5 is separated from the valve seat 6, so that the fluid will be able to flow through the flow path 4.

The axial displacement of the movable member 9 that causes the relative displacement between the valve body 5 and the valve seat 6 as described above can be achieved by the expansion or contraction of the working fluid chamber 8 caused by the feeding or discharging of the working fluid. To achieve this, specifically, the fluid control device 1 can be provided with a fluid pressure actuator 13 having a working fluid chamber 8.

The fluid pressure actuator 13 can have various shapes and structures as long as it can displace the movable member 9 in the axial direction by feeding or discharging the working fluid to or from the working fluid chamber 8. In this embodiment, the fluid pressure actuator 13 has a substantially cylindrical shape further surrounding the movable member 9 around the elastic tube member 12 forming the flow path 4 between the one flow path member 10 and the other flow path member 11. As a result, the fluid pressure actuator 13 has a structure different from that of the actuator that protrudes in a part of the circumferential direction of the flow path-forming member, such as the above device described in the Patent Literature 2, so that it is possible to easily displace the valve body 5 and the valve seat 6 along the axial direction by the fluid pressure actuator 13. Further, according to this structure, the fluid control device 1 can be made compact, so that the constraints on the installation space of the fluid control device 1 can be easily satisfied. In this case, the contact of the fluid with the fluid pressure actuator 13 is prevented by the elastic tube member 12 on the inner side thereof.

The fluid pressure actuator 13 in the illustrated example includes: a cylindrical body 14 that surrounds the increased diameter portion 12a of the elastic tube member 12 and is arranged on the outer peripheral side of the movable member 9; a fitted ring 15 that is fitted to an end portion of the cylindrical body 14 around the movable member 9; and a plate member 16 attached to the fitted ring 15.

The end portion of the cylindrical body 14 has an inward flange portion 14a extending toward the movable member 9 side; and two annular wall portions 14b, 14c protruding in the axial direction on an end face of the inward flange portion 14a, the two annular wall portions 14b, 14c being spaced apart from each other in the radial direction. The fitted ring 15 is provided with a tubular inner wall 15b and outer wall 15c, respectively, at the radially inner and outer ends of a ring body 15a. The two annular walls 14b, 14c of the cylinder body 14 are fitted between the inner wall 15b and the outer wall 15c of the fitted ring 15 so that the fitted ring 15 is fitted to the end portion of the cylinder 14. In this fitted ring 15, four gaps are provided at equal intervals in the circumferential direction between the ring body 15a and the annular portion 17 integrally formed with the ring body 15a, and each of the four plate members 16 is fitted and attached to each of those gaps.

The working fluid chamber 8 is formed around the movable member 9 over its entire circumference as a space defined by the inward flange portion 14a, the annular wall portions 14b, 14c, the ring body 15a, the inner wall 15b and the outer wall 15c. Between the outer wall 15c and the annular wall portion 14b, and between the inner wall 15b and the annular wall portion 14c, an annular sealing member such as an O-ring for preventing leakage of the working fluid from the working fluid chamber 8 can be provided.

The position adjacent to the annular wall portion 14b in a part of the circumferential direction of the inward flange portion 14a or the like of the cylindrical body 14 can be provided with a working fluid passage 14d which is in communication with the working fluid chamber 8 and is used for feeding and discharging the working fluid. In the interior of the inward flange portion 14a, the working fluid passage 14d has a tapered opening extending in the radial direction and having an inner diameter gradually decreasing toward the inner side in the radial direction, and a small hole that extends from the deepest part of the opening and bends in the middle in the axial direction, which is in communication with the working fluid chamber 8 that is present beyond that small hole.

In the fluid pressure actuator 13 described above, the working fluid chamber 8 is expanded by feeding the working fluid, so that the fitted ring 15 is displaced together with the movable member 9 in the axial direction toward the other flow path member 11 side. On the other hand, when the working fluid is discharged from the working fluid chamber 8, the fitted ring 15 is displaced in the axial direction together with the movable member 9 toward the one flow path member 10 to contract the working fluid chamber 8, so that the elastic member 7 can be arranged around the other flow path member 11. In the illustrated embodiment, the elastic member 7 is arranged at the position around the other flow path member 11 and on the outer peripheral side than the elastic tube member 12 and adjacent to the fluid pressure actuator 13 as described above, while being brought into contact with the annular portion 17 located on the most other flow path member 11 side of the fluid pressure actuator 13 in the axial direction. This allows the elastic member 7 to urge the valve seat 6 that is a part of the elastic tube member 12 in the axial direction, in a direction closer to the valve body 5, via the fitted ring 15 of the fluid pressure actuator 13 and the movable member 9.

The elastic member 7, which can be, for example, a coil spring or the like, is preferably arranged on an outer side of the flow path 4 so as to surround the flow path 4, as described above. This makes it possible to check and adjust the operating states of the fluid pressure actuator 13 and the elastic member 7 from the outside of the flow path 4. In this case, for example, a stopper or other physical means (not shown) outside the flow path 4 can be used to adjust the opening/closing state of the flow path 4 by the valve body 5 and the valve seat 6. Further, here, the chemical liquid or the like as the fluid flowing through the flow path 4 is not brought into contact with the elastic member 7, so that any corrosion of the elastic member 7 due to the chemical liquid or the like can be prevented.

By the way, the embodiment for forming the valve element 5 at the tip portion of the one flow path member 10 is not particularly limited, but in this embodiment, the one flow path member 10 includes: the valve body 5 at the tip portion; the cylindrical flow path portion 10a located on the rear end side (rear side in the flow direction) of the flow path member 10; and the connecting portion 10b that connects the valve body 5 to the cylindrical flow path portion 10a. The connecting portion 10b is provided with at least one communication hole 10c for communicating the interior of the cylindrical flow path portion 10a with the internal space of the elastic tube member 12 around the one flow path member 10. Such a communication hole 10c allows the fluid that has flowed from the inflow port 2 to flow through the cylindrical flow path portion 10a and then into the internal space of the elastic tube member 12 via the communication hole 10c.

In this case, in order to achieve a smooth flow of the fluid from the cylindrical flow path portion 10a to the internal space of the elastic tube member 12, the communication holes 10c are spaced apart from each other around the one flow path member 10. In this example, four circular communication holes 10c are formed at equal intervals around the one flow path member 10. In addition, as a result, the connecting portions 10b will be formed into multiple, e.g., four, pillar-shaped members, which are positioned across the communication holes 10c in the circumferential direction of the one flow path member 10.

For the shape of the valve body 5, the surface of the valve body 5 facing the valve seat 6 side (front side in the flow direction) preferably includes: an annular convex portion 5a such as an annular ring protruding toward the valve seat 6 side at the peripheral edge of the surface; and a central convex portion 5b at a center of the surface that gradually protrudes on the valve seat 6 side toward the center side. Here, the height of the central convex portion 5b protruding toward the valve seat 6 is higher than that of the annular convex portion 5a. When the annular convex portion 5a is provided, the adhesiveness of the valve body 5 to the valve seat 6 is greatly enhanced due to, for example, line contact at the annular convex portion 5a upon seating of the valve body 5 on the valve seat 6, so that any unintentional leakage of the fluid between them can be suppressed. Further, when the central convex portion 5b is provided, the fluid passing through the valve body 5 smoothly flows on the slope of the central convex portion 5b upon positioning of the valve body 5 away from the valve seat 6.

On the other hand, it is preferable that substantially the entire back surface of the valve body 5, which is the back side of the above surface (back side in the flow direction), has a conical shape that protrudes rearwardly in the flow direction toward the central side. As a result, the fluid flowing through the cylindrical flow path portion 10a can be smoothly guided from the communication hole(s) 10c to the inner space of the elastic tube member 12 by that conical back surface of the valve body 5, so that the pressure loss at that time can be decreased.

However, the shape of the valve body 5 is not limited to that shown in the drawing, and various shapes including known shapes are possible.

The fluid control device 1 shown in FIGS. 1 to 7 further includes a housing 18 having a substantially rectangular parallelepiped outer shape, which houses the above members, as an exterior. The housing 18 is constructed by abutting and engaging an inflow port side housing member 18a and an outflow port side housing member 18b to each other at their opening side ends. However, in the present invention, the housing 18 can be omitted because the fluid control device 1 can function as well by the above arrangement without the housing 18 as described above.

In the illustrated embodiment, each of the inflow port side housing member 18a and the outflow port side housing member 18b has a through hole 19a or 19a through which the cylindrical flow path portion 10a of the one flow path member 10 or the other flow path member 11 is passed. Each of the outer peripheral surfaces of the cylindrical flow path portion 10a of the one flow path member 10 and the other flow path member 11 is provided with a stepped portion by which the peripheral edge portion of the through hole 19a or 19b is caught. Then, by inserting a fixing ring 20a or 20b from the outside of the housing 18 into each outer peripheral surface of the cylindrical flow path portion 10a and the other flow path member 11, the peripheral edge portion of the through hole 19a or 20b is sandwiched between the stepped portion and the fixing ring 20a or 20b to fix each of the one flow path member 10 and the other flow path member 11 to the housing 18.

The inflow port side housing member 18a is also provided with a hole 21 that exposes a part of the fluid pressure actuator 13 including the working fluid passage 14d to the outside.

FIGS. 8 to 10 show the one and other flow path members and the elastic tube member in the fluid control device according to another embodiment, which are taken out from the fluid control device. FIGS. 8 to 10 omit the members other than the one and other flow path members and the elastic tube member, but the other members may be substantially the same as those of the fluid control device 1 shown in FIGS. 1 to 7, for example.

The embodiment shown in FIG. 8 has substantially the same configuration as that of the fluid control device 1 in FIGS. 1 to 7, with the exception that the elastic tube member 42 is not provided with the easily deformable portion in which the large diameter portion and the small diameter portion are connected between the other flow path member 41 and the movable member, and the portion corresponding to easily deformable portion has the same diameter as that of the intermediate portion 42b.

In FIG. 9, the positions of the valve body 55 and the valve seat 56 are interchanged. More specifically, the intermediate portion 62b of the elastic tube member 62 is provided with the valve body 55 protruding toward the one flow path member 60 side, and the tip surface of the one flow path member 60 is provided with the valve seat 56. The valve body 55 is connected to the intermediate portion 62b by a connecting portion 60b, and at least one communicating hole 60c is formed at the connecting portion 60b.

In this case, an elastic member (not shown) is provided so as to urge the valve body 55 toward the valve seat 56 in the approaching direction, and a working fluid chamber such as a working pressure actuator (also not shown) is provided so as to expand in the direction of separating the valve body 55 from the valve seat 56 against the elastic member by feeding the working fluid.

Other configurations can be the same as those of the fluid control device 1 shown in FIGS. 1 to 7.

It should be noted that even if the valve body 5, 55 and the valve seat 6, 55 are arranged in any arrangement embodiment shown in FIGS. 1 to 7 and 9, the elastic member can urge the valve seat in the separating direction of the valve body from the valve seat and the working fluid chamber can expand in the approaching direction of the valve body to the valve seat by feeding the working fluid, for example, by arranging the elastic member at the one flow path member 10, 40 side and reversing the direction of the working fluid chamber.

Also, the embodiment of FIG. 10 eliminates the easily deformable portion 62c provided between the other flow path member 61 and the movable member in the elastic tube member 82 shown in FIG. 9, and allows the intermediate portion 82b to extend with the same diameter to the other flow path member 81 side.

Each embodiment as shown in FIGS. 8 to 10, the fluid flows from the inflow ports 32, 52, 72 on the right side of the figure to the outflow ports 33, 53, 73 on the left side of the figure, but the inflow ports 32, 52, 72 and the outflow ports 33, 53, 73 can be interchanged to allow the fluid to flow in the opposite direction.

For the fluid control device described above, examples of materials for the elastic tube member include fluororesins such as PTFE and PFA, and elastomeric materials such as rubbers and silicones.

### Examples

Next, the fluid control device according to the present invention was experimentally produced and its effects were confirmed as described below. However, the description herein is merely for the purpose of illustration and is not intended to be limited thereto.

For each of the fluid control device according to Example as shown in FIGS. 1 to 7 and the fluid control device according to Comparative Example as described in Patent Literature 2, a test was conducted by allowing the fluid to flow through the flow path and measure a pressure of the fluid on the inflow port side and a pressure of the fluid on the outflow port side while separating the valve body from the valve seat at farthest to open the flow path, and determining a differential pressure between those pressures. Here, multiple tests were conducted with varying fluid flow rates. The results are shown in a graph of FIG. 11.

It is found from FIG. 11 that the fluid control device according to Example always has a smaller differential pressure than the fluid control device according to Comparative Example regardless of the flow rate of the fluid, indicating that the pressure loss is improved by about 35%.

Also, in the above test, the power consumption required for the operation of the pump for causing the liquid to flow through the flow path was as shown in FIG. 12. It is found from FIG. 12 that the fluid control device according to Example can reduce the power consumption as compared to the fluid control device according to Comparative Example.

As described above, according to the fluid control device of the present invention, it is possible to suppress the pressure loss when the controlling fluid passes therethrough.

### DESCRIPTION OF REFERENCE NUMERALS

1 fluid control device
2, 32, 52, 72 inflow port
3, 33, 53, 73 outflow port
4, 34, 54, 74 flow path
5, 35, 55, 75 valve body
5a annular convex portion
5b central convex portion
6, 36, 56, 76 valve seat
7 elastic member
8 working fluid chamber
9 movable member
10, 40, 60, 80 one flow path member
10a, 40a, 60a, 80a cylindrical flow path portion
10b, 40b, 60b, 80b connecting portion
10c, 40c, 60c, 80c communication hole
11, 41, 61, 81 other flow path member
12, 42, 62, 82 elastic tube member
12a, 42a, 62a, 82a increased diameter portion
12b, 42b, 62b, 82b intermediate portion
12c, 62c easily deformable portion
13 fluid pressure actuator
14 cylindrical body
14a inward flange portion
14b, 14c annular wall
14d working fluid passage
15 fitted ring
15a ring body
15b inner wall
15c outer wall
16 plate member
17 annular portion
18 housing
18a inflow port side housing member
18b outflow port side housing member
19a, 19b through hole
20b fixing ring
21 hole
CL flow path central axis
CL1 flow path central axis at valve body or valve seat
CL2 flow path central axis on inflow port side
CL3 flow path central axis on outflow port side

1. A fluid control device for controlling a flow of a fluid, the fluid control device comprising:
a flow path having an inflow port and an outflow port, the flow path being configured to allow a controlling fluid to flow along the flow path;
a valve body arranged in the flow path between the inflow port and the outflow port;
a valve seat on which the valve body can be seated;
an elastic member for urging the valve seat or the valve body in a direction of approaching or separating the valve body to or from the valve seat; and
a working fluid chamber that expands or contracts in the direction of separating or approaching the valve body from or to the valve seat by feeding or discharging a working fluid;
wherein a part of the valve body is present on an extension line of a linear flow path central axis on the inflow port side across the valve body and the valve seat, and on an extension line of a linear flow path central axis on the outflow port side; and
wherein the valve seat or the valve body is displaceable in at least one axial direction of the linear flow path center axis on the inflow port side and the linear flow path central axis on the outflow port side.

2. The fluid control device according to claim 1, wherein the extension line of the linear flow path central axis at the inflow port is parallel to the extension line of the linear flow path central axis at the outflow port.

3. The fluid control device according to claim 3, wherein the extension line of the linear flow path central axis at the inflow port coincides with the extension line of the linear flow path central axis at the outflow port.

4. The fluid control device according to claim 3, wherein the extension line of the linear flow path central axis at the inflow port and the extension line of the linear flow path central axis at the outflow port passes through a center of a cross section of the valve body along a plane orthogonal to the extension lines.

5. The fluid control device according to claim 1, wherein the elastic member is arranged on an outer side of the flow path so as to surround the flow path.

6. The fluid control device according to claim 1, wherein the fluid control device further comprises:
a cylindrical movable member displaceable in the axial direction;
a pair of flow path members each having an inflow port or an outflow port, the pair of flow path members being positioned on both sides across the movable member; and
an elastic tube member disposed between the pair of flow path members, the elastic tube member being deformable in accordance with relative approaching and separating displacement of the valve seat to and from the valve body;
wherein the valve body is located at a tip portion of a first one of the pair of flow path members, and a part of the elastic tube member in the axial direction is supported from a back side of the elastic tube member by the movable member to form the valve seat.

7. The fluid control device according to claim 6, wherein both central axes of the movable member and the pair of flow path members are on the same straight line as the linear flow path central axes on the inflow port side and the outflow port side.

8. The fluid control device according to claim 6, wherein the fluid control device further comprises a fluid pressure actuator provided around the movable member, the fluid pressure actuator having the working fluid chamber and operating to displace the movable member in the axial direction by feeding or discharging the working fluid to or from the working fluid chamber.

9. The fluid control device according to claim 8, wherein the elastic member is arranged at a position adjacent to the fluid pressure actuator on an outer peripheral side of the elastic tube member around a second one of the pair of flow path members.

10. The fluid control device according to claim 6, wherein the first one of the pair of flow path members comprises:
the valve body at the tip portion;
a cylindrical flow path portion located on a rear end side of the first one of the pair of flow path members; and
a connecting portion for connecting the valve body to the cylindrical flow path portion;
wherein the connecting portion has at least one communicating hole formed to communicate an interior of the cylindrical flow path portion with an internal space of the elastic tube member around the first one of the pair of flow path members.

11. The fluid control device according to claim 10, wherein the communication holes are formed at intervals around the first one of the pair of flow path members.

12. The fluid control device according to claim 1, wherein a surface of the valve body facing the valve seat side comprises:
an annular convex portion protruding toward the valve seat side at a peripheral edge of the surface; and
a central convex portion at a center of the surface, the central convex portion gradually protruding on the valve seat side toward the center side.

13. The fluid control device according to claim 1, wherein a back surface on a back side of the valve body facing the valve seat side has a conical shape.
